(19) United States
(12) Patent Application Publication
(10) Pub. No.: US 2002/0089179 A1
(43) Pub. Date: Jul. 11, 2002

(54) Hose coupling apparatus and method

(76) Inventor: Levon Guyumjan, Long Beach, CA (US)

Correspondence Address: CHARLES R. SUTTON, 14507 SYLVAN ST., STE. 208, VAN NUYS, CA, 91411, US

(21) Appl. No.: 10/079,095

(22) Filed: Feb. 20, 2002

Related U.S. Application Data
(60) Provisional application No. 60/259,405, filed on Dec. 30, 2000.

(51) Int. Cl. F16L 33/00

(52) U.S. Cl. 285/242; 285/247

(57) ABSTRACT

An apparatus and method of clamping a hose to a nipple using a conical adaptation of two inclined planes sliding against one another outside the hose. The force brought to bear against the surface of the hose by action of these inclined surfaces can be increased or decreased by means of threading a sleeve onto or off of the exposed threaded region of the nipple which is beyond the region enclosed by the hose. The inclined inside of the sleeve urges an inclined sheath or sheaths ever more tightly against the outside of the hose as a retaining ring is tightened onto the nipple. This in turn urges the inside of the hose ever more tightly against the nipple.

### CROSS-REFERENCES TO RELATED APPLICATIONS

This application is for improvements over the invention disclosed in provisional application No. 60/259405 dated Dec. 30, 2000 by the same inventor.

### STATEMENT AS TO RIGHTS TO INVENTIONS MADE UNDER FEDERALLY-SPONSORED RESEARCH AND DEVELOPMENT

This invention was not made under Federally sponsored research and development. The rights are retained by the inventor.

### BACKGROUND OF THE INVENTION

1. Field of the Invention

This invention falls into the art area of hose couplings or hose connectors.

2. Description of the Related Art Including Information Disclosed Under 37 CFR Sections 1.97 and 1.98.

Hoses have been used to convey fluids from one place to another for many years. Often, it is necessary to fasten the hose to a fluid source or to another hose. In the past, this has been accomplished by means of a coupling mechanism such as a nipple onto which the hose fits and a hose clamp which fits around the outside of the hose and holds it onto the nipple by means of pressure. Sometimes a screw type mechanism is used to tighten the hose clamp onto the hose. Sometimes it is a lever, such as that seen in the case of a cable tie gun being used to tighten a cable tie around the hose. The nipples are often flanged and they may have a series of parallel flanges on their exteriors which are meant to prevent the common problem of the hose slipping off the nipple due to the fluid pressure inside the hose. This problem can result in accidents and lost production for a company. Sometimes the nipple is made wider as one proceeds from its tip to its base, again with a decreased hose slippage rate being the desired outcome of the design. Unfortunately, this conical tendency and the series of flanges discussed above can have the undesirable effect of making it very difficult to put the hose onto the nipple. This is especially true in the case of hoses that are designed to withstand high pressures, since they will have relatively low elasticity. Flex hose slips readily off PVC nipples known to the art today. Most clamps known to the art today are rated at only up to about 150 PSI in terms of their capacity to hold hose onto a nipple. Some clamping techniques such as cable ties (or tie wraps) are not reusable, which is an additional problem in the prior art.

### SUMMARY OF THE INVENTION

This invention provides a hose coupling and clamping mechanism, especially for flex hoses from ⅛ inch to 1.5 inches, braided metal steam hoses, and bulk hoses from 1.5″ to 3″ that is easy to use in that the difficulty of inserting the nipple into the hose is minimized. The invention provides a coupling that can safely withstand a much higher fluid pressure than the rating of the clamps currently known to the art. This invention solves the problems by means of a mechanism that can be produced much more cheaply than most hose clamps currently on the market and it is reusable. In its best mode, the invention comprises a straight cylindrical nipple (1) which may have an annular rounded ridge (2) on its outside. The rounding of the ridge is so that the interior of the hose will not be damaged by a sharp nipple flange when the hose is clamped to the nipple. Conical outsides or those with other contours may be used, but the inventor considers these other shapes less optimal. At the end of the nipple opposite from the end that the hose would fit onto, there is an optimally cylindrical region of larger diameter which has first outside screw threads (3) on its outside. This Cylindrical region is here called a screw fitting (4).

A sleeve (5) is also included in the invention which is hollow through its axis. The sleeve has two cylindrical portions fixedly joined end to end with one of the cylinders having a greater diameter than the other. The inside diameter of the hollow region is greater at one end than the other. Referring now to FIG. 3, the reader can see at the cross section taken at plane (6), the inside diameter of the sleeve decreases at an angular step (7) that corresponds to the fixed joint region of the sleeve. The narrower inside diameter is inside the narrower of the two joined cylinders. The broader inside diameter region corresponds to the joined cylinder of broader diameter. The inside surface of the end of the sleeve that has the lesser inside diameter has first inside threads (8) that match the outside threads on the screw fitting. On the outside of the sleeve in the region of greater inside diameter are second outside threads (9). The best substance for constructing the nipple and the sleeve currently contemplated by the inventor is stainless steel.

The invention also contains one sheath (10). Referring now to FIG. 4, a cross section of the sheath taken along plane (11) reveals the sheath forms a tube that is cylindrical in shape along its inside surface. A slice (12) runs the length of the sheath. It is as if a hollow cylinder was sliced one time lengthwise from the outside surface to the inside surface to produce the sheath. The outside of the sheath is not perfectly cylindrical, though. At one end is an angular beveled region (13) angled to correspond with the angle of the angular step inside the sleeve. The inside diameter of the sheath conforms substantially to the outside diameter of the nipple. The sheath may be composed of an inexpensive substance such as plastic in many applications, but if it is to be used in clamping braided metal steam hoses and the like, it must be composed of metal to be safe. There is also a retaining ring (14) which is a cylinder with a bore. Referring to FIG. 5, a cross sectional view of the retaining ring taken at plane (15), the reader can see that at one end of the bore is second inside threads (16) which correspond to the second outside threads. At the other end of the bore is a region of reduced bore diameter forming a sheath stop (17).

Referring now to FIG. 6 an additional feature of the sheath (10) can be seen. The beveled region (13) ends in a riser (18) that is perpendicular to the line of the axis of the sheath. This riser corresponds to a similar perpendicular region ending the angular step (7) inside the sleeve. In use, the retaining ring is first placed over the hose, then the sheath is placed over the hose, then the sleeve is placed over the hose. The hose is then placed onto the nipple and the sleeve is screwed onto the first outside threads of the nipple. The sheath is slid along the hose into the broader inside diameter region of the sleeve and then the retaining ring is screwed onto the second outside threads of the sleeve. In this way the sheath is urged against the angular step so that the beveled region interacts with the angular step to compress the sheath into a cylinder of lesser diameter. This in turn compresses the hose tightly against the nipple. The riser (18) eventually meets the mating perpendicular terminus of the angular step (7) so the sheath is prevented from being urged any further into the hose. The sleeve (5) can be used to push against the riser (18) when it is time to remove the sheath from the hose, adding to the convenience of the invention and the reusability of the sheath.

### BRIEF DESCRIPTION OF THE DRAWINGS

FIG. 1 shows the hose nipple.

FIG. 2 shows the sleeve from the side.

FIG. 3 shows a cross-sectional view of the sleeve.

FIG. 4 shows a cross-sectional view of the sheath.

FIG. 5 shows a cross sectional view of the retaining ring.

FIG. 6 shows the exploded diagram of the invention.

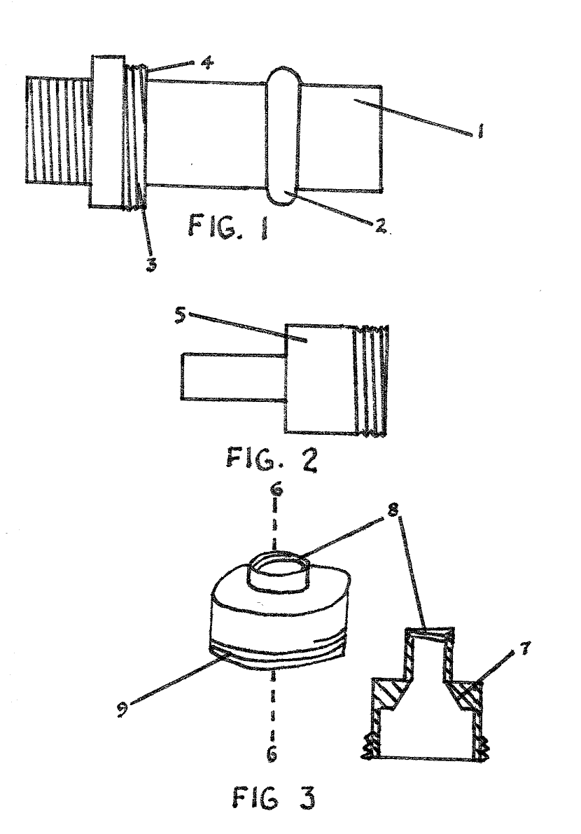

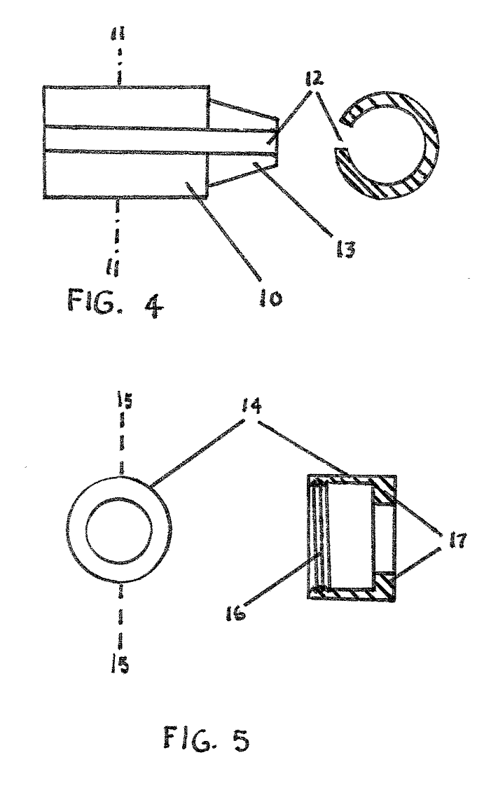

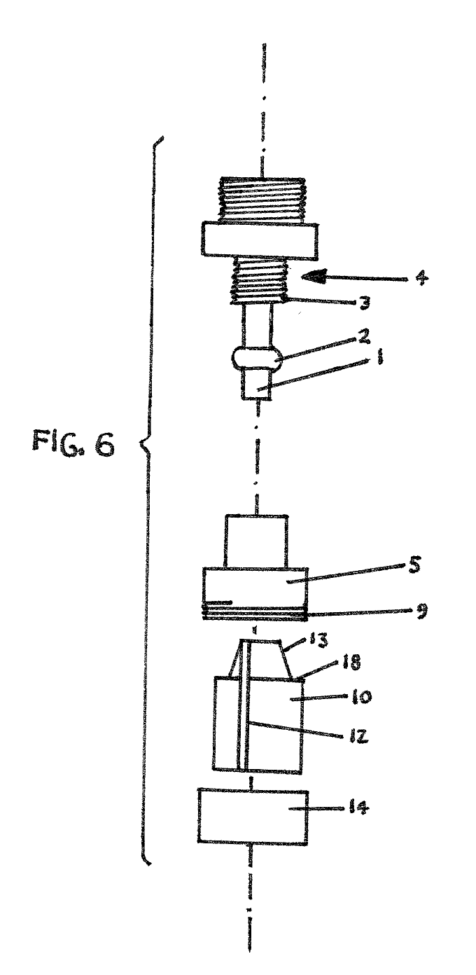

### DESCRIPTION OF THE PREFERRED EMBODIMENT

To assemble the pieces described above in the summary of the invention, one would first place the retaining ring (14) over the outside of a hose with an inside diameter of appropriate size to fit over the nipple (1). Looked at another way, one would be inserting said hose through the axial void that penetrates the retaining ring. (Remember that the sheath stop (17) must be away from the end of the hose which will go on the nipple, not toward it). Next the sheath (10) is placed over the hose with the narrower end of the sheath being toward the end of the hose which will go onto the nipple. The sleeve (5) is then placed onto the hose. (Remember that the region of narrower inside diameter on the sleeve must be toward the end of the hose which will be placed on the nipple.) Then slide the hose of suitable inside diameter onto the narrow non-threaded region of the nipple (1). Slide the sleeve up to the end of the hose and begin to turn it so that its first inside threads (8) engage the first outside threads (3) on the larger diameter (probably cylindrical) portion of the nipple. Slide the sheath (10) into the sleeve (5). The second inside threads (16) of the retaining ring (14) are screwed onto the second outside threads (9) of the sleeve (5). As the second inside threads are tightened onto the second outside threads, the sheath will be urged ever more forcefully against the outside of the hose due to the inclined plane type action between the outside of the sheath and the inside of the sleeve. This force will be substantially uniform over the entire outside of the hose which is covered by the sheath. The force in turn will urge the inside of the hose ever more forcefully against the narrower portion of the nipple over which it has been placed. Using hand strength coupled with the inclined plane concept and screw threads in this way, it is possible easily to couple a hose to a nipple so that it will not slip free despite far more pounds per square inch of fluid pressure than can be held with clamps currently known to the art. Stronger, thicker hoses can be clamped with an embodiment of the invention having an angular beveled region (13) that has a sharper angle of attack (closer to perpendicular to the axis of the sheath, less acute to the axis of the sheath) because each turn of the second inside threads onto the second outside threads will lead to increased pressure against the hose as opposed to the pressure created by a screw turn of a retaining ring against a sheath having an angular beveled region more acute to the axis of the sheath. Sheaths having a gentler angle of attack in their angular beveled regions are appropriate for use with more delicate hoses. The user must remember to use appropriately matched sheath and sleeve pieces or the fitting will not assemble or clamp properly.

I claim:

1. In combination:
a nipple having a first axis and a first outer surface having an end adapted to fit inside a hose, said nipple being substantially cylindrical and having a first bore through said first axis, said outer surface having a raised region distal to said end, said raised region having first outer threads disposed in an annular manner;
a sleeve comprising a smaller diameter cylinder having a second axis, said smaller diameter cylinder fixedly joined to a larger diameter cylinder having a third axis so that said second axis and said third axis are aligned, said sleeve having a second bore through said second axis and said third axis, said second bore increasing in diameter as it passes from said smaller diameter cylinder to said larger diameter cylinder, said second bore having first inside threads annularly disposed inside said smaller diameter cylinder, said larger diameter cylinder having a second outer surface and second outside threads annularly disposed on said second outer surface;
a sheath having a fourth axis with a substantially cylindrical third bore penetrating said fourth axis, said sheath having a third outer surface with a slit, a cylindrical region and a beveled region, said beveled region being frustoconical and increasing in diameter in the direction of said cylindrical region, said cylindrical region having a greater diameter than said beveled region, said slit communicating between said third bore and said third outer surface;
a retaining ring having a substantially cylindrical fourth outer surface and a fifth axis, said fifth axis being penetrated by a fourth bore, said fourth bore having annularly disposed second inside threads and a retaining stop, said retaining stop being of narrower diameter than the remainder of said fourth bore;
said second bore, said third bore, and said fourth bore each admitting said hose for which the nipple is adapted;
said first inside threads being adapted to screw onto said first outside threads;
said second inside threads being adapted to screw onto said second outside threads; and
said sheath fitting inside said second bore and said fourth bore when said second inside threads are screwed onto said second outside threads, said sheath being compressed against said hose for which the nipple is adapted as said second inside threads are screwed onto said second outside threads.

2. The combination of claim 1 in which said first outer surface has a cincture with a rounded surface.

3. The combination of claim 1 further comprising:
said second bore having a first region of constant diameter in the region of said first inside threads followed by a region of linearly increasing diameter followed by a first stepwise increase of diameter to a second region of constant diameter;
said third outer surface having a second stepwise increase of diameter between said beveled region and said cylindrical region; and
said first stepwise increase in diameter cooperating with said second stepwise increase in diameter to stop screw progression of said second inside threads onto said second outside threads before compression of said sheath can damage said hose.

4. The combination of claim 1 in which said nipple has means to connect to other plumbing distal to said end.

5. A hose fitting having:
a nipple having a first axis and a first outer surface having an end adapted to fit inside a hose, said nipple being substantially cylindrical and having a first bore through said first axis, said outer surface having first connection means;
a sleeve comprising a smaller diameter cylinder having a second axis, said smaller diameter cylinder joined to a larger diameter cylinder having a third axis so that said second axis and said third axis are aligned, said sleeve having a second bore through said second axis and said third axis, said second bore increasing in diameter as it passes from said smaller diameter cylinder to said larger diameter cylinder, said sleeve having second connection means on said smaller diameter cylinder and third connection means on said larger diameter cylinder;
a sheath having a fourth axis with a substantially cylindrical third bore penetrating said fourth axis, said sheath having a third outer surface with a slit, a cylindrical region and a beveled region, said beveled region being frustoconical and increasing in diameter in the direction of said cylindrical region, said cylindrical region having a greater diameter than said beveled region, said slit communicating between said third bore and said third outer surface;
a retaining ring having a substantially cylindrical fourth outer surface, fourth connection means, and a fifth axis, said fifth axis being penetrated by a fourth bore with a retaining stop, said retaining stop being of narrower diameter than the remainder of said fourth bore;
said second bore, said third bore, and said fourth bore each admitting said hose for which the nipple is adapted;
said first connection means connecting to said second connection means;
said third connection means connecting to said fourth connection means; and
said sheath fitting inside said second bore and said fourth bore and being urged against said hose when said third connection means is connected to said fourth connection means.

6. The hose fitting of claim 5 in which said first outer surface has a cincture with a rounded surface.

7. The hose fitting of claim 5 further comprising:
said second bore having a first region of constant diameter inside said smaller diameter cylinder followed by a region of linearly increasing diameter followed by a first stepwise increase of diameter to a second region of constant diameter;
said third outer surface having a second stepwise increase of diameter between said beveled region and said cylindrical region;
said first stepwise increase in diameter cooperating with said second stepwise increase in diameter to prevent said beveled region from moving against said region of linearly increasing diameter enough to damage said hose when said third connection means is connected to said fourth connection means.

8. The hose fitting of claim 5 in which said nipple has fifth connection means for connecting to plumbing.
